(19) United States
(12) Patent Application Publication
(10) Pub. No.: US 2025/0267167 A1
(43) Pub. Date: Aug. 21, 2025

(54) ELECTRONIC APPARATUS, CONTROL METHOD, AND NON-TRANSITORY COMPUTER-READABLE STORAGE MEDIUM STORING PROGRAM

(71) Applicant: SEIKO EPSON CORPORATION, Tokyo (JP)

(72) Inventor: Kazuma SATO, SHIOJIRI-SHI (JP)

(21) Appl. No.: 19/056,196

(22) Filed: Feb. 18, 2025

(30) Foreign Application Priority Data
Feb. 20, 2024 (JP) 2024-023567

(51) Int. Cl. H04L 9/40; H04L 61/4511

(52) U.S. Cl. CPC H04L 63/145; H04L 63/1416; H04L 61/4511

(57) ABSTRACT

An electronic apparatus includes: a detector configured to detect intrusion of malware into the electronic apparatus by detecting a name resolution error that occurs for a DNS packet transmitted from the electronic apparatus; and a countermeasure execution unit configured to reboot the electronic apparatus and execute a setting change of the electronic apparatus when intrusion of malware is detected. In the setting change, at least one of the following is performed: (1) changing at least one of a detection period for occurrence of the name resolution error and a threshold for the number of occurrences of the name resolution error for determining intrusion of malware; (2) blocking packet transmission to a predetermined port; (3) disabling wireless communication; and (4) disabling wired communication.

The present application is based on, and claims priority from JP Application Serial Number 2024-023567, filed Feb. 20, 2024, the disclosure of which is hereby incorporated by reference herein in its entirety.

### BACKGROUND

### 1. Technical Field

The present disclosure relates to an electronic apparatus, a control method, and a non-transitory computer-readable storage medium storing a program.

### 2. Related Art

Various techniques for coping with malware have been proposed. For example, JP-T-2019-500712 discloses a system that detects malware infecting a computing device. JP-T-2019-500712 is an example of the related art.

The technique disclosed in JP-T-2019-500712 is a technique focused only on detecting malware infection, and countermeasures taken when malware infection is detected are left to a user. Therefore, a burden on the user is large.

### SUMMARY

An electronic apparatus according to the present disclosure includes: a detection unit configured to detect intrusion of malware into the electronic apparatus by detecting a name resolution error that occurs for a domain name system (DNS) packet transmitted from the electronic apparatus; and a countermeasure execution unit configured to reboot the electronic apparatus and execute a setting change of the electronic apparatus when intrusion of malware is detected. In the setting change, at least one of the following is performed: (1) changing at least one of a detection period for occurrence of the name resolution error and a threshold for the number of occurrences of the name resolution error for determining intrusion of malware; (2) blocking packet transmission to a predetermined port; (3) disabling wireless communication; and (4) disabling wired communication.

A control method according to the present disclosure is a control method for an electronic apparatus, the method including: detecting intrusion of malware into the electronic apparatus by detecting a name resolution error that occurs for a domain name system (DNS) packet transmitted from the electronic apparatus; and rebooting the electronic apparatus and executing a setting change of the electronic apparatus when intrusion of malware is detected. In the setting change, at least one of the following is performed: (1) changing at least one of a detection period for occurrence of the name resolution error and a threshold for the number of occurrences of the name resolution error for determining intrusion of malware; (2) blocking packet transmission to a predetermined port; (3) disabling wireless communication; and (4) disabling wired communication.

A non-transitory computer-readable storage medium storing a program according to the present disclosure, the program causing a computer of an electronic apparatus to execute: a detection step of detecting intrusion of malware into the electronic apparatus by detecting a name resolution error that occurs for a DNS packet transmitted from the electronic apparatus; and a countermeasure execution step of rebooting the electronic apparatus and executing a setting change of the electronic apparatus when intrusion of malware is detected. In the setting change, at least one of the following is performed: (1) changing at least one of a detection period for occurrence of the name resolution error and a threshold for the number of occurrences of the name resolution error for determining intrusion of malware; (2) blocking packet transmission to a predetermined port; (3) disabling wireless communication; and (4) disabling wired communication.

### BRIEF DESCRIPTION OF THE DRAWINGS

FIG. 1 is a block diagram illustrating an example of a configuration of an electronic apparatus according to an embodiment.

FIG. 2 is a block diagram illustrating an example of functions implemented by firmware.

FIG. 3 illustrates an example of a GUI screen for setting detection processing of a detection unit.

FIG. 4 is a schematic diagram illustrating an example of a GUI screen for receiving an instruction regarding performing a setting change from a user.

FIG. 5 is a flowchart illustrating an example of a flow of operations of the electronic apparatus according to the embodiment.

FIG. 6 is a flowchart illustrating an example of a flow of processing in step S107 in FIG. 5.

FIG. 7 is a schematic diagram illustrating another detection method executed by the detection unit.

FIG. 8 is a schematic diagram illustrating an example of information displayed by an information output unit.

### DESCRIPTION OF EMBODIMENTS

Hereinafter, an embodiment will be described with reference to the drawings. To clarify the description, omission and simplification have been made as appropriate in the description and the drawings below. In the drawings, the same elements are denoted by the same reference signs, and the redundant description thereof is omitted as necessary.

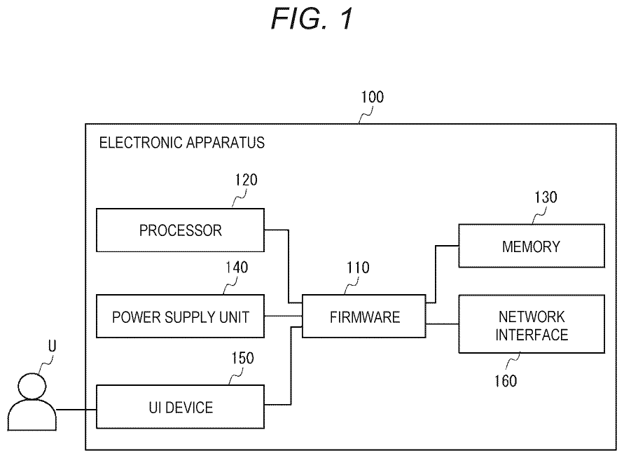

FIG. 1 is a block diagram illustrating an example of a configuration of an electronic apparatus 100 according to an embodiment. As illustrated in FIG. 1, the electronic apparatus 100 includes firmware 110, a processor 120, a memory 130, a power supply unit 140, a user interface (UI) device 150, and a network interface 160. The electronic apparatus 100 is, for example, an embedded device such as a printer, and is not limited thereto. It is sufficient that the electronic apparatus 100 is an information processing apparatus that performs information processing. In the embodiment, since the electronic apparatus 100 is connected to a network such as the Internet, the electronic apparatus 100 can also be referred to as an Internet of Things (IoT) device.

The firmware 110 is software that controls an operation of the electronic apparatus 100. In particular, in the embodiment, the firmware 110 is also software having a function of detecting malware and executing a countermeasure against the malware as described later.

The processor 120 reads a program from the memory 130 and executes the program. Accordingly, the processor 120 implements the functions of the firmware 110. Malware intruded into the electronic apparatus 100 also operates using the memory 130 and the processor 120, similarly to the firmware 110. The processor 120 may be, for example, a microprocessor, a microprocessor unit (MPU), or a central processing unit (CPU). The processor 120 may include a plurality of processors.

The memory 130 is implemented by, for example, a combination of a volatile memory and a nonvolatile memory. The memory 130 is used to store a program or the like executed by the processor 120. The memory 130 may include a plurality of memories.

The power supply unit 140 is a circuit that controls the supply of power to units constituting the electronic apparatus 100. In particular, the power supply unit 140 reboots the electronic apparatus 100 under the control of the firmware 110. Specifically, when malware is detected in the electronic apparatus 100, the electronic apparatus 100 is rebooted in accordance with a reboot instruction from the firmware 110.

The UI device 150 is a device that functions as a user interface. Specifically, the UI device 150 includes a display that displays various types of information and an input device such as a button or a pointing device that receives an input operation from a user U. The UI device may be implemented as a touch panel in which a display and an input device are integrated. The UI device 150 is used to notify the user U of information and acquire an instruction from the user U in the processing of the firmware 110. In particular, in the embodiment, the UI device 150 is used when changing settings of the electronic apparatus 100 after rebooting the electronic apparatus 100 in which malware is detected.

The network interface 160 is a network device for the electronic apparatus 100 to communicate with other devices via a network such as the Internet or a local area network (LAN). Specifically, the network interface 160 includes a hardware circuit of a wired LAN terminal or the like for the electronic apparatus 100 to perform wired communication, and a hardware circuit of a Wi-Fi (registered trademark) chip or the like for the electronic apparatus 100 to perform wireless communication. The network interface 160 may include only one of a hardware circuit for wired communication and a hardware circuit for wireless communication. Under the control of the firmware 110, the network interface 160 is switched between a state in which the communication function is enabled and a state in which the communication function is disabled. The switch between a state in which the communication function is enabled and a state in which the communication function is disabled can be performed separately in the wired communication and the wireless communication.

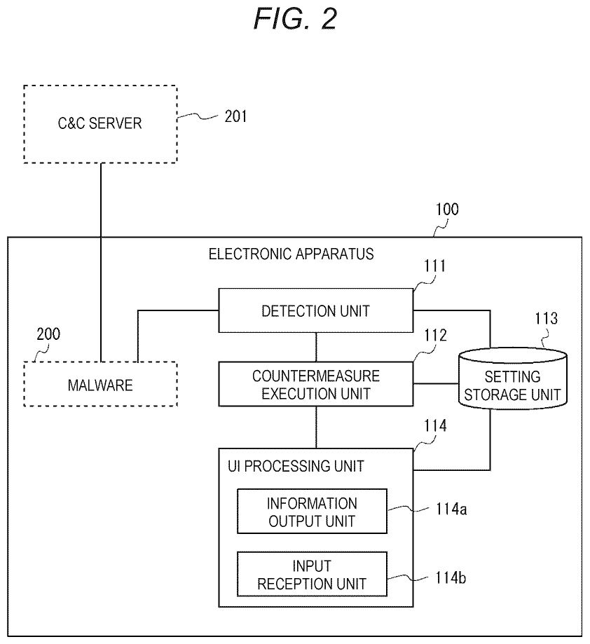

Next, details of the firmware 110 will be described. FIG. 2 is a block diagram illustrating an example of functions implemented by the firmware 110. The electronic apparatus 100 includes a detection unit 111, a countermeasure execution unit 112, a setting storage unit 113, and a UI processing unit 114 as functions of the firmware 110. In FIG. 2, in order to illustrate a relationship between these functions of the firmware 110 and malware 200 intruded into the electronic apparatus 100, the malware 200 and a command and control (C&C) server 201 with which the malware 200 communicates are also illustrated.

The malware 200 is malicious harmful software such as a computer virus, a worm, or spyware, and invades the electronic apparatus 100 (firmware 110) in some way and resides in the memory 130. The malware 200 intrudes into the electronic apparatus 100 via a network, for example. The C&C server 201 is a command server used by a cyber attacker to issue a command to the malware 200 or receive information stolen by the malware 200. Therefore, the malware 200 communicates with the C&C server 201. By this communication, for example, the malware 200 uploads information stored in the electronic apparatus 100 to the C&C server 201. In order to communicate with the C&C server 201, the malware 200 generates a large number of domain names using a domain generation algorithm (DGA), and attempts to communicate with a destination specified by each of the generated domain names. The large number of generated domain names include a domain name of the C&C server 201, but most of the domain names are domain names for which name resolution by a domain name system (DNS) server fails. That is, most of DNS packets for the name resolution of the domain names generated by the domain generation algorithm cause a name resolution error. Here, the DNS packet is a packet for requesting the DNS server to perform the name resolution of the domain name, and may be referred to as a DNS name resolution packet.

The detection unit 111 detects intrusion of the malware 200 into the electronic apparatus 100. In the embodiment, the detection unit 111 detects intrusion of the malware 200 into the electronic apparatus 100 by detecting a name resolution error that occurs with respect to a DNS packet transmitted from the electronic apparatus 100. Specifically, the detection unit 111 performs the following processing to detect the intrusion of the malware 200 into the electronic apparatus 100. The detection unit 111 acquires a response packet to a DNS packet transmitted to the outside of the electronic apparatus 100. Then, the detection unit 111 parses the acquired response packet and checks response information according to RFC 1035 that is a standard related to the domain name. In particular, at this time, the detection unit 111 checks whether the response information included in the response packet includes information indicating a name resolution error. Then, when the number of times of name resolution errors that occur in a predetermined period is equal to or greater than a predetermined threshold, the detection unit 111 determines that the malware 200 intrudes into the electronic apparatus 100. Hereinafter, the predetermined period is referred to as a detection period, and the predetermined threshold is referred to as a detection threshold. In the embodiment, the detection unit 111 performs the above-described detection processing using a value of the detection period and a value of the detection threshold that are stored in the setting storage unit 113 described later. Although initial values are set in advance for the value of the detection period and the value of the detection threshold, the values can be changed by the countermeasure execution unit 112 when the malware 200 is detected by the detection unit 111, as will be described later. As described above, when the malware 200 intrudes into the electronic apparatus 100, it is assumed that many name resolution errors occur in the name resolution of the domain names generated by the domain generation algorithm. Therefore, the detection unit 111 can detect the intrusion of the malware 200 by monitoring the DNS packet as described above.

The countermeasure execution unit 112 executes a countermeasure when the intrusion of the malware 200 is detected by the detection unit 111. Specifically, first, when the intrusion of the malware 200 is detected by the detection unit 111, the countermeasure execution unit 112 reboots the electronic apparatus 100 in order to eliminate the malware 200 that intrudes therein. More specifically, for example, the countermeasure execution unit 112 reboots the electronic apparatus 100 by issuing an instruction of reboot to the power supply unit 140. Accordingly, the malware 200 operating on the memory 130 serving as a volatile memory is eliminated when data in the memory 130 is deleted by reboot.

After the reboot of the electronic apparatus 100, the countermeasure execution unit 112 changes settings of the electronic apparatus 100 as a countermeasure against the intrusion of the malware 200. In the embodiment, specifically, the countermeasure execution unit 112 executes the following setting changes (1) to (4) in accordance with an execution instruction from the user U. The countermeasure execution unit 112 may execute any one of the following setting changes (1) to (4), or may execute two or more setting changes that are freely combined.

### Setting Change (1): Changing Setting Value of Detection Processing

The countermeasure execution unit 112 changes a setting value of the detection processing performed by the detection unit 111. Specifically, the setting value is changed so that the intrusion of the malware 200 is detected more easily than at present. More specifically, the countermeasure execution unit 112 changes a value of the detection period to be larger than a current setting value. That is, when changing the detection period as a countermeasure, the countermeasure execution unit 112 changes the detection period to a period having a length longer than a length of the currently set detection period. The countermeasure execution unit 112 changes a value of the detection threshold to be smaller than a current setting value. That is, when changing the detection threshold as a countermeasure, the countermeasure execution unit 112 changes the value of the threshold to a value smaller than a value of the currently set threshold. The countermeasure execution unit 112 may change only one of the detection period and the detection threshold. That is, the countermeasure execution unit 112 changes at least one of the detection period of the occurrence of the name resolution error and the threshold for the number of occurrences of the name resolution error for determining intrusion of malware. By changing the setting value of the detection processing by the countermeasure execution unit 112, even when the malware 200 intrudes into the electronic apparatus 100 again, the intrusion can be detected at an early stage.

### Setting Change (2): Blocking Packet Transmission to Predetermined Port

The countermeasure execution unit 112 may perform a setting change of transmission control protocol (TCP) communication or user datagram protocol (UDP) communication to block transmission of a packet to a predetermined port used to wait for a DNS packet. Specifically, for example, the countermeasure execution unit 112 blocks transmission of a packet addressed to a TCP/UDP port 53. That is, the countermeasure execution unit 112 blocks packet transmission to a port having a port number 53 used in TCP or UDP. For example, the countermeasure execution unit 112 instructs the network interface 160 to block transmission of a packet addressed to a predetermined port. When the transmission of the packet to the predetermined port is blocked by the countermeasure execution unit 112, the transmission of a DNS packet to the DNS server can be blocked. Therefore, even when the malware 200 intrudes into the electronic apparatus 100 again, it is possible to prevent the malware 200 from communicating with the C&C server 201. Therefore, damage caused by the malware 200 can be restricted.

### Setting Change (3): Disabling Wireless Communication

The countermeasure execution unit 112 changes communication settings of the electronic apparatus 100 to disable wireless communication of the electronic apparatus 100. Specifically, the countermeasure execution unit 112 disables Wi-Fi communication by stopping operation of a device driver of the network interface 160 that performs processing related to wireless communication. Accordingly, it is possible to restrict the malware 200 from intruding into the electronic apparatus 100 again. Even if the malware 200 intrudes into the electronic apparatus 100, it is possible to restrict the malware 200 from communicating with the C&C server 201 and to restrict damage caused by the malware 200.

### Setting Change (4): Disabling Wired Communication

The countermeasure execution unit 112 changes communication settings of the electronic apparatus 100 to disable wired communication of the electronic apparatus 100. Specifically, the countermeasure execution unit 112 interrupts Ethernet communication by stopping operation of a device driver of the network interface 160 that performs processing related to wired communication. Accordingly, the countermeasure execution unit 112 disables communication that uses a LAN port (that is, an Ethernet port). Accordingly, it is possible to restrict the malware 200 from intruding into the electronic apparatus 100 again. Even if the malware 200 intrudes into the electronic apparatus 100, it is possible to restrict the malware 200 from communicating with the C&C server 201 and to restrict damage caused by the malware 200.

In the embodiment, the countermeasure execution unit 112 executes some or all of the above-described setting changes when there is a change instruction from the user U, and may execute some or all of the above-described setting changes regardless of the instruction from the user U. Although the setting changes (1) to (4) are exemplified as specific examples of the setting change, the setting change executed by the countermeasure execution unit 112 is not limited thereto, and another setting change such as a setting change for degenerating the function of the electronic apparatus 100 may be executed.

The setting storage unit 113 stores setting information of the electronic apparatus 100. In the embodiment, the setting storage unit 113 stores the setting values of the detection period and the detection threshold used by the detection unit 111 for the detection processing. Therefore, when changing the setting value of the detection processing performed by the detection unit 111, the countermeasure execution unit 112 stores a setting value after change in the setting storage unit 113. That is, the countermeasure execution unit 112 updates the setting value stored in the setting storage unit 113. The setting storage unit 113 is not limited to storing the setting values of the detection period and the detection threshold, and may further store other types of information. For example, setting information on settings to be changed in the above-described setting changes (2) to (4) may be stored in the setting storage unit 113 as necessary. For example, information for setting whether to perform the detection processing by the detection unit 111 may be stored. In this case, the detection unit 111 executes the detection processing when setting information indicating that the detection process is to be executed is stored, and does not execute the detection processing when setting information indicating that the detection processing is not to be executed is stored. Specifically, the setting storage unit 113 is implemented by any storage device. For example, the setting storage unit 113 may be implemented by the memory 130 or may be implemented by an auxiliary storage device such as a hard disk drive or a solid state drive.

The UI processing unit 114 performs processing related to a user interface. In the embodiment, the UI processing unit 114 includes an information output unit 114a that performs output processing for notifying the user U of information, and an input reception unit 114b that performs processing of receiving an input from the user U.

The information output unit 114a outputs a graphical user interface (GUI) screen, and the input reception unit 114b acquires information input on the GUI screen. The information output unit 114a outputs a GUI screen on a display of the UI device 150, for example. The input reception unit 114b acquires information input on the GUI screen displayed by the UI device 150. Specifically, for example, the information output unit 114a outputs a GUI screen that includes information on settings of the electronic apparatus 100 and a GUI component for receiving an input. In addition, the input reception unit 114b acquires information that is input on the GUI screen by an operation on the GUI component for receiving an input (for example, a selection operation from options or an input operation of information to an input box).

The information output unit 114a and the input reception unit 114b may not use the UI device 150. The information output unit 114a may output information on a web browser installed on a terminal device such as a smartphone, a tablet terminal, or a personal computer used by the user U, which can communicate with the electronic apparatus 100, thereby displaying the information on the terminal device. The input reception unit 114b may acquire information input via the web browser from the terminal device capable of communicating with the electronic apparatus 100. Specifically, for example, the information output unit 114a outputs, as a GUI screen, a configuration page including information on settings of the electronic apparatus 100 and a GUI component for receiving an input. The input reception unit 114b acquires information input on the configuration page by an operation on the GUI component for receiving an input (for example, a selection operation from options or an input operation of information to an input box).

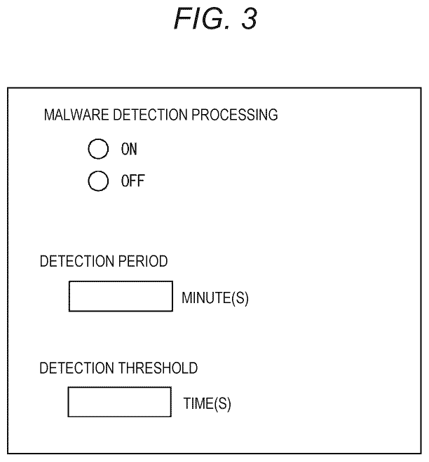

As will be described later, in the embodiment, the UI processing unit 114 performs interaction with the user U when the detection unit 111 detects intrusion of the malware 200 into the electronic apparatus 100. The UI processing unit 114 may perform interaction with the user U in other cases. For example, the user U may freely change the initial value of the detection period and the initial value of the detection threshold. The user U may be able to change the value of the detection period or the detection threshold, which is changed by the countermeasure execution unit 112, to an original initial value or any value. The user U may be able to set whether to perform malware detection processing by the detection unit 111. FIG. 3 is an example of a GUI screen for setting the detection processing of the detection unit 111. In the example illustrated in FIG. 3, a setting of whether to perform malware detection processing, a setting of the detection period, and a setting of the detection threshold can be received on the GUI screen from the user U. Without being limited to the detection period or the detection threshold, a GUI screen for receiving an instruction to restore any or all of the settings changed by the countermeasure execution unit 112 may be displayed. As described above, the GUI screen may be displayed on the web browser of the terminal device of the user U or may be displayed on the UI device 150 of the electronic apparatus 100. As described above, the UI processing unit 114 may perform processing of displaying a GUI screen for receiving input of various settings, and may perform processing of storing, in the setting storage unit 113, setting information input on the GUI screen by the user U. The information output unit 114a of the UI processing unit 114 may read a default initial value or a current setting value of the detection period or the detection threshold from the setting storage unit 113 and display the default initial value or the current setting value on the GUI screen. One or both of the initial value of the detection period and the initial value of the detection threshold may have a specification in which a free change by the user U is not allowed.

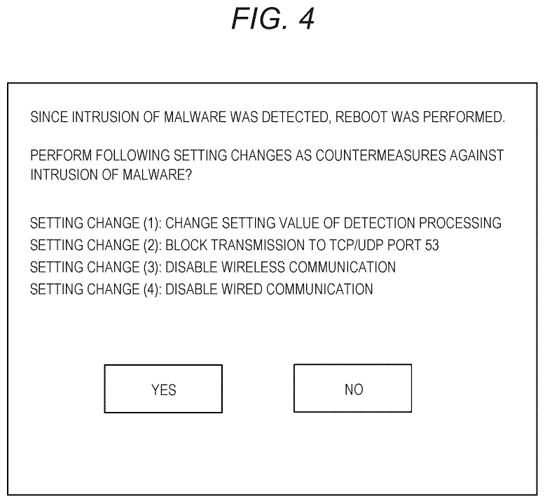

In particular, in the embodiment, when the detection unit 111 detects intrusion of the malware 200 into the electronic apparatus 100, the UI processing unit 114 performs interaction with the user U. Specifically, the UI processing unit 114 performs processing of receiving an instruction from the user U regarding execution of the above-described setting changes by the countermeasure execution unit 112. For example, after the detection unit 111 detects the intrusion of the malware 200 and the countermeasure execution unit 112 performs reboot processing, the information output unit 114a of the UI processing unit 114 performs processing of displaying, for example, a GUI screen illustrated in FIG. 4. FIG. 4 is a schematic diagram illustrating an example of a GUI screen for receiving an instruction regarding execution of a setting change from the user U. In the example illustrated in FIG. 4, an instruction as to whether to execute a setting change can be received on the GUI screen from the user U. An input from the user U on the GUI screen is received by the input reception unit 114b of the UI processing unit 114. The GUI screen may include a message for warning the user U that intrusion of the malware 200 is detected or a message for notifying the user U that reboot is performed. These messages may be displayed on a screen different from the screen for receiving an instruction from the user U as to whether to execute a setting change. On the GUI screen illustrated in FIG. 4, the user U is inquired whether to execute a setting change without specifying the setting to be changed, and a GUI screen for inquiring whether to execute the setting change may be displayed for each item to be changed. That is, the information output unit 114a of the UI processing unit 114 may perform processing of displaying a GUI screen for inquiring of the user U whether to execute the setting change for each of the above-described setting changes (1) to (4). The input reception unit 114b may receive, from the user U, an input indicating whether to execute the setting change for each of the setting changes (1) to (4).

In the embodiment, the countermeasure execution unit 112 executes the above-described setting change when the UI processing unit 114 (input reception unit 114b) receives an input instructing execution of the setting change from the user U. For example, when a button for instructing performing is pressed on the GUI screen, the setting change is performed. When execution of setting change is instructed only for some change items among the setting changes (1) to (4), the countermeasure execution unit 112 executes only the setting change instructed to be executed. As described above, in the embodiment, the countermeasure execution unit 112 performs the setting change according to an instruction from the user U. Accordingly, it is possible to prevent a setting change not desired by the user U from being executed.

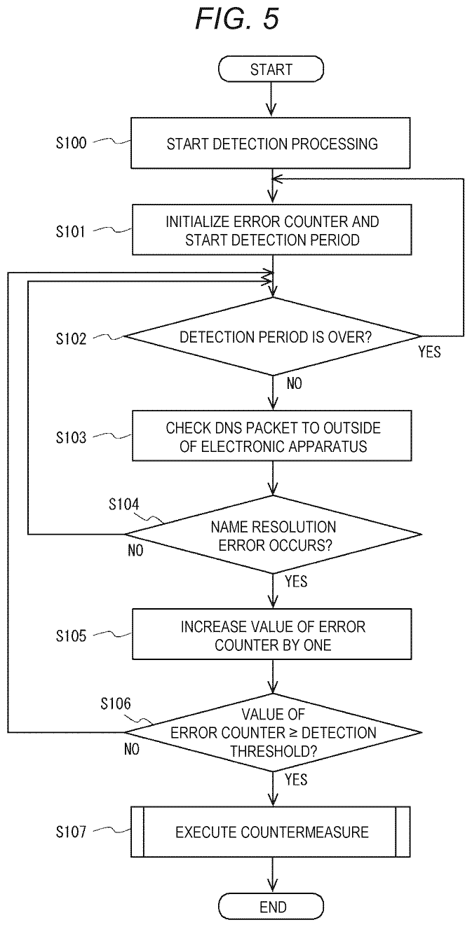

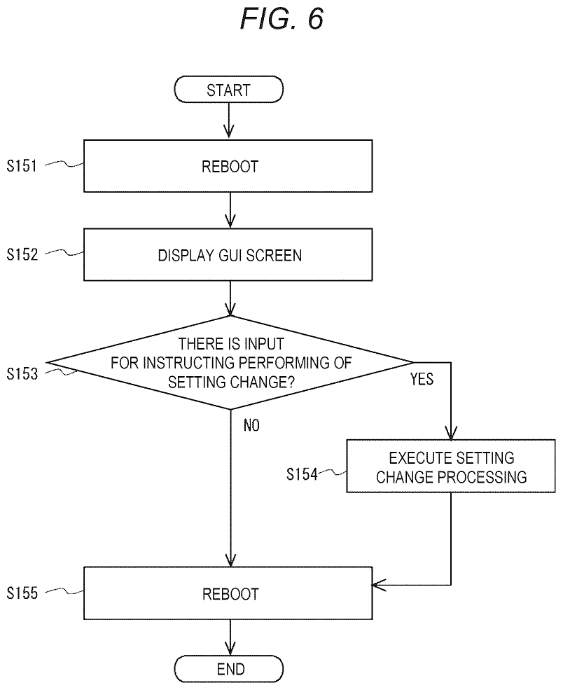

Next, a flow of operations of the electronic apparatus 100 will be described. FIG. 5 is a flowchart illustrating an example of a flow of operations of the electronic apparatus 100. FIG. 6 is a flowchart illustrating an example of a flow of processing of step S107 in FIG. 5. Hereinafter, the flow of operations of the electronic apparatus 100 will be described with reference to FIGS. 5 and 6.

In step S100, the detection unit 111 starts detection processing for the malware 200. Accordingly, in step S101, the detection unit 111 initializes a value of an error counter, which is a variable for counting the number of occurrences of the name resolution error, to 0. Then, the detection period starts. Since the malware 200 is not detected at this time point, a period set as an initial value is used as the detection period. The period as the initial value may be, for example, 5 minutes or 1 week, and is not limited thereto and may be any period. In step S102, the detection unit 111 checks whether the detection period is over. If the detection period is not over (NO in step S102), the process proceeds to step S103. On the other hand, if the detection period is over, the process returns to step S101 to reset a result of the detection processing so far and start the next detection processing.

In step S103, the detection unit 111 checks a DNS packet transmitted from the electronic apparatus 100 to the outside. More specifically, the detection unit 111 checks a response packet to the transmitted DNS packet. In step S104, the detection unit 111 checks whether the response packet includes information indicating a name resolution error. That is, the detection unit 111 checks whether a name resolution error occurs for the DNS packet. If a name resolution error occurs (YES in step S104), the process proceeds to step S105. On the other hand, if no name resolution error occurs (NO in step S104), the process returns to step S102. If name resolution is normally performed or an error other than the name resolution error occurs, the process returns to step S102.

In step S105, the detection unit 111 increments the value of the error counter by 1. Subsequently, in step S106, the detection unit 111 determines whether the value of the error counter is equal to or greater than a detection threshold. Since the malware 200 is not detected at this time point, a threshold set as an initial value is used as the detection threshold. The initial value may be, for example, 4 or 100, and is not limited thereto and may be any value. If the value of the error counter is less than the detection threshold (NO in step S106), the process returns to step S102. On the other hand, if the value of the error counter is equal to or greater than the detection threshold (YES in step S106), the process proceeds to step S107. That is, in this case, the detection unit 111 determines that the electronic apparatus 100 is intruded by malware.

In step S107, countermeasures against the intrusion of the malware 200 are taken. Hereinafter, a specific flow of processing of step S107 will be described with reference to FIG. 6. First, in step S151, the countermeasure execution unit 112 reboots the electronic apparatus 100 in order to eliminate the malware 200 that intrudes into the electronic apparatus 100. Accordingly, the malware 200 existing in the memory 130 is eliminated. In the flowchart illustrated in FIG. 6, in step S151, the electronic apparatus 100 is started in a setting mode that is a mode for enabling a setting change.

Next, in step S152, the information output unit 114a of the UI processing unit 114 displays, on the display or the like of the UI device 150, a GUI screen for receiving an instruction from the user U regarding execution of a setting change. On the GUI screen, as illustrated in FIG. 4, contents of setting changes that can be executed as a countermeasure against the malware 200 may be displayed. The GUI screen may include warning information for warning that intrusion of malware 200 into the electronic apparatus 100 occurs. The information output unit 114a may display such warning information separately from the GUI screen for receiving an instruction from the user U regarding execution of a setting change.

After step S152, in step S153, the countermeasure execution unit 112 determines whether an input instructing execution of a setting change is received by the input reception unit 114b. That is, in this step, it is determined whether the user U presses a button that is provided on the above-described GUI screen and instructs execution of a setting change. As described above, the user U may instruct whether to perform the setting change for each change item. If the user U instructs execution of a setting change (YES in step S153), the process proceeds to step S154. On the other hand, if the user U does not instruct execution of a setting change (NO in step S153), the process proceeds to step S155.

In step S154, the countermeasure execution unit 112 performs processing for executing the setting change instructed by the user U. Thereafter, the process proceeds to step S155.

In step S155, the countermeasure execution unit 112 reboots the electronic apparatus 100 in order to start in a normal mode. When the processing for setting change is performed in step S154, the electronic apparatus 100 is started in a state in which the change is reflected in the electronic apparatus 100 by the reboot. When the reboot is not necessary to reflect the setting change in the electronic apparatus 100, the reboot in step S155 may be omitted. In this case, in the reboot in step S151, the electronic apparatus 100 is rebooted not in the setting mode but in the normal mode.

In the flowchart illustrated in FIG. 6, the setting change is performed according to the instruction of the user U. Alternatively, as described above, the setting change may be performed without requiring an instruction from the user U. In this case, the display of a GUI screen may be omitted.

The embodiment has been described above. In the embodiment, when intrusion of the malware 200 into the electronic apparatus 100 is detected by the detection processing performed by the detection unit 111, the countermeasure execution unit 112 executes a setting change of the electronic apparatus 100. Therefore, it is possible to easily take countermeasures against the intrusion of malware. That is, according to the embodiment, since not only detection of malware but also implementation of countermeasures is performed, it is possible to reduce a burden on the user. Specifically, by performing any one of the setting changes (1) to (4) described above, it is possible to take countermeasures such as prevention of re-intrusion of the malware 200 or early detection of the malware 200. In particular, the detection unit 111 determines the intrusion of the malware 200 into the electronic apparatus 100 by checking the number of occurrences of a name resolution error. The countermeasure execution unit 112 performs processing with a relatively small processing load such as reboot or the setting changes (1) to (4). Therefore, it is easy to implement the detection processing and the countermeasure processing after the detection even in the electronic apparatus 100 having limited computer resources such as an embedded device.

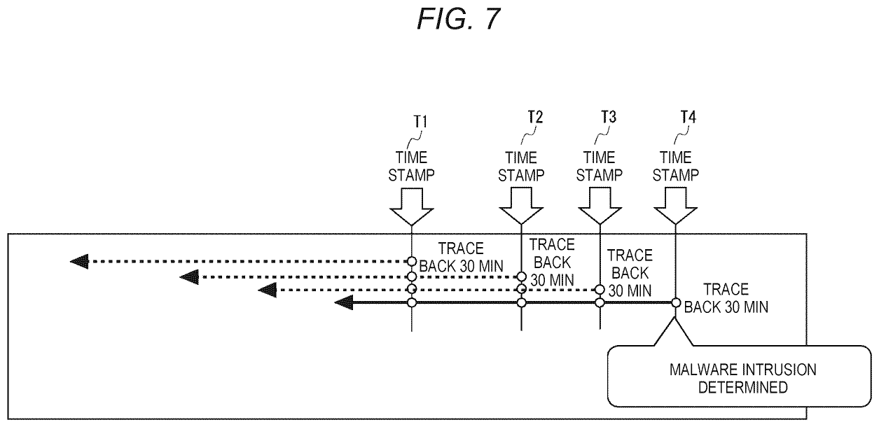

Next, some modifications of the above-described embodiment will be described. The detection unit 111 described with reference to the flowchart illustrated in FIG. 5 detects intrusion of the malware 200 into the electronic apparatus 100 by comparing a detection threshold with the number of occurrences of a name resolution error occurring until an elapsed time from a certain time point exceeds a predetermined detection period. However, the detection unit 111 may detect intrusion of the malware 200 into the electronic apparatus 100 as follows. FIG. 7 is a schematic diagram illustrating another detection method executed by the detection unit 111. As illustrated in FIG. 7, the detection unit 111 may detect intrusion of the malware 200 into the electronic apparatus 100 by comparing a detection threshold (4 in the example in FIG. 7) with the number of occurrences of a name resolution error that occurs during a period from a nearest occurrence time point of the name resolution error to a time point traced back a time (30 minutes in the example in FIG. 7) corresponding to a detection period. In this case, every time the name resolution error occurs, the detection unit 111 records a time stamp indicating the occurrence time point in the memory 130. The detection unit 111 refers to the recorded time stamps and specifies the number of name resolution errors that occur during a period from an occurrence time point of the latest name resolution error to a time point traced back the time corresponding to the detection period. When this number exceeds the detection threshold, the detection unit 111 determines that the malware 200 intrudes into the electronic apparatus 100. In the example in FIG. 7, the name resolution error occurs four times, and the respective occurrence time points are recorded as time stamps T1 to T4. Therefore, at the occurrence time point of the name resolution error that is recorded as the time stamp T4, the detection unit 111 determines that the malware 200 intrudes into the electronic apparatus 100. This is because the total number of name resolution errors that occur during a period from the time point indicated by the time stamp T4 to a time point traced back 30 minutes is equal to or greater than the detection threshold (4 times). The detection unit 111 may perform the detection processing based on the number of occurrences of the name resolution error, and the specific detection processing is not limited to the method shown in the present disclosure.

The countermeasure execution unit 112 may disable only one of the wireless communication and the wired communication, based on which of the wireless communication and the wired communication is used to transmit the DNS packet for which the name resolution error occurs. In this case, for example, the countermeasure execution unit 112 determines whether the transmission of the DNS packet, for which the name resolution error occurs, is performed by the wireless communication or the wired communication by checking a communication log regarding transmission of packets from the electronic apparatus 100. That is, the countermeasure execution unit 112 analyzes whether the communication by malware is performed using wireless communication or wired communication. When the communication used for the transmission of the DNS packet, for which the name resolution error occurs, is biased to one of the wireless communication and the wired communication, the countermeasure execution unit 112 disables one of the wireless communication and the wired communication that is more frequently used for the transmission of the DNS packet for which the name resolution error occurs. For example, when communication by malware is performed using only wired communication, only wired communication is disabled. Accordingly, it is possible to continue communication for normal processing using a communication method that is not disabled. For example, the user U can perform any setting change such as returning the setting of the electronic apparatus 100 via the web browser using the communication method that is not disabled.

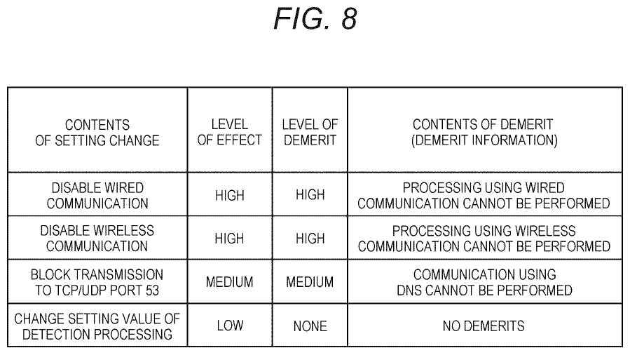

For example, when receiving an input instructing execution of a setting change, the information output unit 114a may output information indicating a demerit of each change items in the setting change. Accordingly, the user U can recognize the demerit and determine whether to execute the setting change. For example, the information output unit 114a may perform processing of displaying information as illustrated in FIG. 8. As illustrated in FIG. 8, the information output unit 114a may output a level of the demerit for each change item, or may output a level of a relative effect compared to other change items for each change item. For example, for a setting change of disabling wired communication and a setting change of disabling wireless communication, the information output unit 114a outputs demerit information indicating that processing using wired communication or wireless communication cannot be performed, a demerit level being “high”, and an effect level being “high”. For example, for a setting change of blocking transmission to a predetermined port (TCP/UDP port 53), the information output unit 114a outputs demerit information indicating that communication using DNS cannot be performed, a demerit level being “medium”, and an effect level being “medium”. For example, for a setting change of changing a setting value of the detection processing, the information output unit 114a outputs demerit information indicating that there is no demerit, a demerit level being “none”, and an effect level being “low”. These are merely examples, and information other than the above-described information may be output as the demerit information, the demerit level, or the effect level for each change item.

In the present disclosure, the program includes a command group (or software codes) for causing a computer to perform one or more functions described in the embodiment when the program is read by the computer. The program may be stored in a non-transitory computer-readable medium or a tangible storage medium. Examples of the computer-readable medium or the tangible storage medium include, but are not limited to, a random-access memory (RAM), a read-only memory (ROM), a flash memory, a solid-state drive (SSD) or devices based on other memory technologies, a CD-ROM, a digital versatile disc (DVD), a Blu-ray (trademark registered) disc or other optical disc storages, a magnetic cassette, a magnetic tape, a magnetic disk storage or other magnetic storage devices. The program may be transmitted on a transitory computer-readable medium or a communication medium. Examples of the transitory computer-readable medium or the communication medium include, but are not limited to, a propagation signal of an electric, optical, acoustic, or another form.

While the embodiment has been described above, the present disclosure is not limited to the above embodiment and changes can be made without departing from the spirit and scope of the present disclosure. A part or the entirety of the above embodiment can be described as in the following appendixes but is not limited thereto.

### Appendix 1

An electronic apparatus including:
a detection unit configured to detect intrusion of malware into the electronic apparatus by detecting a name resolution error that occurs for a domain name system (DNS) packet transmitted from the electronic apparatus; and
a countermeasure execution unit configured to reboot the electronic apparatus and execute a setting change of the electronic apparatus when intrusion of malware is detected, in which
in the setting change, at least one of the following is performed:
(1) changing at least one of a detection period for occurrence of the name resolution error and a threshold for the number of occurrences of the name resolution error for determining intrusion of malware;
(2) blocking packet transmission to a predetermined port;
(3) disabling wireless communication; and
(4) disabling wired communication.

### Appendix 2

The electronic apparatus according to Appendix 1, in which
when changing the detection period, the countermeasure execution unit changes the detection period to a period having a length longer than a length of the detection period that is currently set.

### Appendix 3

The electronic apparatus according to Appendix 1 or 2, in which when changing the threshold, the countermeasure execution unit changes a value of the threshold to a value smaller than a value of the threshold that is currently set.

### Appendix 4

The electronic apparatus according to any one of Appendixes 1 to 3, in which
the port is a port having a port number of 53 used in transmission control protocol (TCP) or user datagram protocol (UDP).

### Appendix 5

The electronic apparatus according to any one of Appendixes 1 to 4, in which
the countermeasure execution unit disables only one of the wireless communication and the wired communication based on which of the wireless communication and the wired communication is used to transmit the DNS packet for which the name resolution error occurs.

### Appendix 6

The electronic apparatus according to any one of Appendixes 1 to 5, in which
the countermeasure execution unit performs the setting change according to an instruction from a user.

### Appendix 7

The electronic apparatus according to any one of Appendixes 1 to 6, further including:
an information output unit configured to output information indicating a demerit of each of change items in the setting change.

### Appendix 8

A control method for an electronic apparatus, including:
detecting intrusion of malware into the electronic apparatus by detecting a name resolution error that occurs for a domain name system (DNS) packet transmitted from the electronic apparatus; and
rebooting the electronic apparatus and executing a setting change of the electronic apparatus when intrusion of malware is detected, in which
in the setting change, at least one of the following is performed:
(1) changing at least one of a detection period for occurrence of the name resolution error and a threshold for the number of occurrences of the name resolution error for determining intrusion of malware;
(2) blocking packet transmission to a predetermined port;
(3) disabling wireless communication; and
(4) disabling wired communication.

### Appendix 9

A non-transitory computer-readable storage medium storing a program, the program causing a computer of an electronic apparatus to execute:
a detection step of detecting intrusion of malware into the electronic apparatus by detecting a name resolution error that occurs for a domain name system (DNS) packet transmitted from the electronic apparatus; and
a countermeasure execution step of rebooting the electronic apparatus and executing a setting change of the electronic apparatus when intrusion of malware is detected, in which
in the setting change, at least one of the following is performed:
(1) changing at least one of a detection period for occurrence of the name resolution error and a threshold for the number of occurrences of the name resolution error for determining intrusion of malware;
(2) blocking packet transmission to a predetermined port;
(3) disabling wireless communication; and
(4) disabling wired communication.

What is claimed is:

1. An electronic apparatus comprising:
a detector configured to detect intrusion of malware into the electronic apparatus by detecting a name resolution error that occurs for a domain name system (DNS) packet transmitted from the electronic apparatus; and
a countermeasure execution unit configured to reboot the electronic apparatus and execute a setting change of the electronic apparatus when intrusion of malware is detected, wherein
in the setting change, at least one of the following is performed:
(1) changing at least one of a detection period for occurrence of the name resolution error and a threshold for the number of occurrences of the name resolution error for determining intrusion of malware;
(2) blocking packet transmission to a predetermined port;
(3) disabling wireless communication; and
(4) disabling wired communication.

2. The electronic apparatus according to claim 1, wherein
when changing the detection period, the countermeasure execution unit changes the detection period to a period having a length longer than a length of the detection period that is currently set.

3. The electronic apparatus according to claim 1, wherein
when changing the threshold, the countermeasure execution unit changes a value of the threshold to a value smaller than a value of the threshold that is currently set.

4. The electronic apparatus according to claim 1, wherein
the port is a port having a port number of 53 used in transmission control protocol (TCP) or user datagram protocol (UDP).

5. The electronic apparatus according to claim 1, wherein
the countermeasure execution unit disables only one of the wireless communication and the wired communication, based on which of the wireless communication and the wired communication is used to transmit the DNS packet for which the name resolution error occurs.

6. The electronic apparatus according to claim 1, wherein
the countermeasure execution unit performs the setting change according to an instruction from a user.

7. The electronic apparatus according to claim 1, further comprising:
an information output unit configured to output information indicating a demerit of each of change items in the setting change.

8. A control method for an electronic apparatus, comprising:
detecting intrusion of malware into the electronic apparatus by detecting a name resolution error that occurs for a DNS packet transmitted from the electronic apparatus; and
rebooting the electronic apparatus and executing a setting change of the electronic apparatus when intrusion of malware is detected, wherein
in the setting change, at least one of the following is performed:
(1) changing at least one of a detection period for occurrence of the name resolution error and a threshold for the number of occurrences of the name resolution error for determining intrusion of malware;
(2) blocking packet transmission to a predetermined port;
(3) disabling wireless communication; and
(4) disabling wired communication.

9. A non-transitory computer-readable storage medium storing a program, the program causing a computer of an electronic apparatus to execute:
a detection step of detecting intrusion of malware into the electronic apparatus by detecting a name resolution error that occurs for a DNS packet transmitted from the electronic apparatus; and
a countermeasure execution step of rebooting the electronic apparatus and executing a setting change of the electronic apparatus when intrusion of malware is detected, wherein
in the setting change, at least one of the following is performed:
(1) changing at least one of a detection period for occurrence of the name resolution error and a threshold for the number of occurrences of the name resolution error for determining intrusion of malware;
(2) blocking packet transmission to a predetermined port;
(3) disabling wireless communication; and
(4) disabling wired communication.
